(19) United States
(12) Patent Application Publication
(10) Pub. No.: US 2008/0167072 A1
(43) Pub. Date: Jul. 10, 2008

(54) SYSTEM AND METHOD FOR PROVIDING TELEPHONE SERVICE ACCESS VIA A GATEWAY TELEPHONE

(76) Inventors: Viktors Berstis, Austin, TX (US); Herman Rodriguez, Austin, TX (US); Newton J. Smith, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/619,701

(22) Filed: Jan. 4, 2007

(51) Int. Cl. H04M 1/00

(52) U.S. Cl. 455/557

(57) ABSTRACT

The present invention is a method for providing telephone service. The method includes receiving a request at a first telephone from a second telephone to access the first telephone's telephone service in response to the second telephone's inability to access the second telephone's telephone service. The method further includes granting access to the first telephone's telephone service for use by the second telephone in response to receiving the request at the first telephone prompting the first telephone to grant access to the first telephone's telephone service. The request is received by the first telephone from the second telephone via a short-range wireless connection.

### FIELD OF THE INVENTION

The present invention relates to the field of pervasive computing and particularly to a system and method for providing telephone service access via a gateway telephone.

### BACKGROUND OF THE INVENTION

Current mobile phone technology requires a subscriber to a mobile phone service to utilize a phone that is compatible with the mobile phone service's wireless network protocol in order to establish a connection over the telephone network. One drawback with this requirement is that a mobile service provider may limit coverage to certain areas. Another drawback is that a mobile phone user may not be able to make a phone call, even when attempting to make the call from an area claimed to be covered by his mobile service provider. For instance, a user may experience dead spots at certain locations within the claimed coverage area from which the user is unable to access the telephone network, or has insufficient signal strength to make the call. Contrastingly, a second user, located in proximity with the first user, having a different phone or a different service provider from the first user, may not have his ability to connect to the telephone network impeded by these same dead spots.

Therefore, it may be desirable to have a system and method for providing telephone service access which addresses the above-referenced problems and limitations of the current solutions.

### SUMMARY OF THE INVENTION

Accordingly, an embodiment of the present invention is directed to a method for providing telephone service. The method includes receiving a request at a first telephone from a second telephone to access the first telephone's telephone service in response to the second telephone's inability to access the second telephone's telephone service. The method further includes granting access to the first telephone's telephone service for use by the second telephone in response to receiving the request at the first telephone prompting the first telephone to grant access to the first telephone's telephone service. The request is received by the first telephone from the second telephone via a short-range wireless connection.

A further embodiment of the present invention is directed to a system, including: a first telephone configured with a short-range wireless protocol; a second telephone configured with the short-range wireless protocol and further configured for communicatively coupling with the first telephone via a short-range wireless connection, wherein the first telephone is further configured for granting the second telephone access to the first telephone's telephone service via the short-range wireless connection.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustration of a system for providing telephone service access via a gateway telephone in accordance with an exemplary embodiment of the present invention;

FIG. 2 is a flow chart illustrating a method for providing telephone service access via a gateway telephone in accordance with an exemplary embodiment of the present invention;

FIG. 3A is an illustration of a first/gateway telephone in accordance with an exemplary embodiment of the present invention; and

FIG. 3B is an illustration of a second/requesting telephone in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

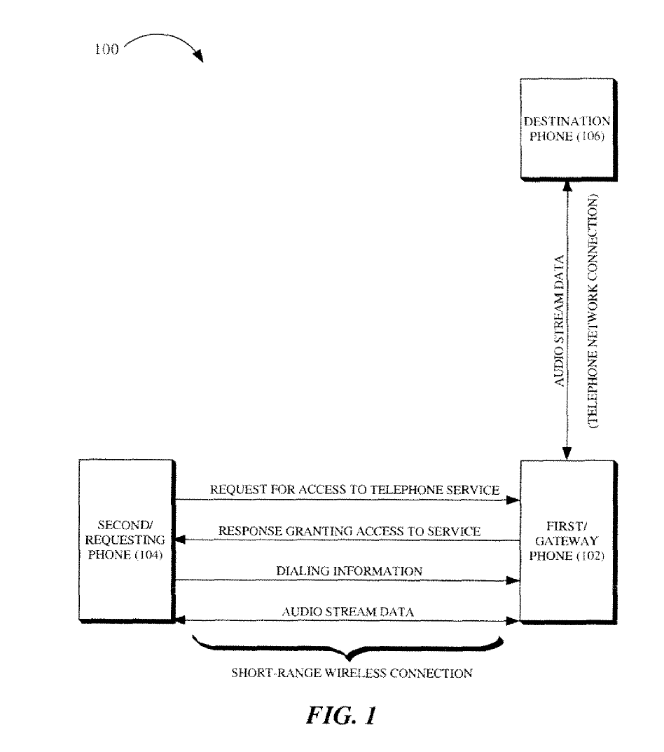

FIG. 1 illustrates a block diagram configuration for a system 100 for providing telephone service access via a gateway telephone in accordance with an exemplary embodiment of the present invention. Included in the illustrated configuration are a first telephone 102, a second telephone 104, and a destination telephone 106. One or more of the first telephone 102, the second telephone 104, and the destination telephone 106 may be a mobile telephone, a cordless telephone, a Voice over IP (VoIP) phone router or the like. In a present embodiment, the first telephone 102 is configured with a short-range wireless connection. The second telephone 104 is also configured with the same short-range wireless connection and is further configured for communicatively coupling with the first telephone 102 via the short-range wireless connection. For instance, the short-range wireless connection may be a secured connection (ex.-requiring a password entry to connect) and/or a wireless network protocol, such as a BLUETOOTH® protocol, for allowing the first and second phones (102, 104) to be communicatively coupled. BLUETOOTH® is a registered certification mark owned by BLUETOOTH SIG, INC. CORPORATION DELAWARE 500 108th Avenue NE, Suite 250 Bellevue, Wash. 98004.

In an exemplary embodiment of the present invention, the first telephone 102 is further configured for granting the second telephone 104 access to the first telephone's telephone service via the short-range wireless connection. For example, a user of the second telephone 104 may be attempting to make a phone call to the destination telephone 106. Further, the user of the second telephone 104 may be a subscriber to a telephone service, such as a wireless telephone service which provides wireless service to the second telephone 104. However, the user of the second telephone 104 may be located in an area not covered by his wireless service's subscription plan. Alternatively, the user of the second telephone 104, despite being in an area that is claimed to be covered by his subscription plan, may be located in a “dead spot” from which he may be unable to establish or sustain a telephone network connection using the second telephone 104. Contrastingly, a user of a first telephone 102, whose phone service is provided by a wireless service provider which is different than the wireless service provider which provides service to the second telephone 104, may be able to establish and sustain a telephone network connection from the same general location as the user of the second telephone 104. This may be due to the fact that, under its subscription plan, the service provider which supplies service to the first telephone 102 supplies wireless service to that area and/or that the first telephone 102 is not in a “dead spot”. Accordingly, the first telephone 102 (i.e., the gateway telephone) is configured for allowing the second telephone 104 to access the telephone service of the first telephone 102, using the short-range wireless connection between the first telephone 102 and the second telephone 104, for making the phone call to the destination telephone 106. For example, if the short-range wireless connection is a BLUETOOTH® connection, the first telephone 102 may communicatively couple (i.e., establish a connection) with the second telephone 104 via the BLUETOOTH® protocol when the second telephone 104 is within range of the first telephone 102. For a BLUETOOTH® connection between phones, the range may be, for instance, within a 35 foot radius.

As discussed above, while the user of the second phone 104 may be unable to establish/sustain a telephone network connection for making a phone call to the destination phone 106, the first telephone 102 is able to establish a telephone network connection. For example, once connected with the first phone 102 via the short-range wireless connection, the second phone 104 may be configured for transmitting a request, via the short-range connection, which requests access to the first telephone's wireless service provider. Further, the first phone 102 is configured for receiving the request from the second phone 104 (i.e., the requesting telephone) via the short-range wireless connection. In a current embodiment, the request may be transmitted and received in a manner that is transparent to both the user of the first phone 102 and the user of the second phone 104. For instance, once connected to the first phone 102 via the short-range wireless connection, the second phone 104, upon detection of a weak or non-existent signal, may automatically send the request to the first phone 102 upon discovery of the first phone 102. Further, the first phone 102 may then receive and grant the request in a transparent manner with respect to the user of the first phone. In further embodiments, the request may be selectively granted by the first phone 102. For example, an authentication and/or authorization mechanism may be implemented which limits access to the first phone 102 via the short-range wireless connection to a registered user or phone. In additional embodiments, the first phone 102 may be configured so that a user of the first phone 102 makes the determination whether or not to grant access, such as requiring the user of the first phone to respond to a prompt or signal received by the first phone 102. In still further embodiments, the user of the first phone 102 may establish the first phone 102 in an access grant or access denial mode, via manipulation of a control of the phone 102 or via an input to the phone 102. In an alternate embodiment, a prompt may be received by the second/requesting phone 104, the prompt requesting a password to be input to phone 104 in order to access the first phone 102. In additional embodiments, a prompt may be received by the second/requesting phone 104 indicating allowance or denial of access. In further embodiments, a user of the requesting/second phone 104 may receive a prompt or dialogue indicating charges that will be incurred by the user of the first phone if access is granted.

Once access has been granted, the second/requesting phone 104 transmits its dialing information via the short-range wireless connection to the first/gateway phone 102. For instance, the user of the second/requesting phone 104 may receive an indication or signal via the second phone 104 sent by the first/gateway phone 102 that access has been granted. The user of the second/requesting phone 104 may then enter a telephone number associated with the destination telephone 106 via an input to the second/requesting phone 104. The second/requesting phone 104 may then transmit dialing information, said dialing information including the telephone number associated with the destination telephone 106, to the first/gateway telephone 102 via the short-range wireless connection.

In the present embodiment, the first/gateway telephone 102 is configured for receiving the dialing information from the second/requesting telephone 104 via the short-range wireless connection. In response to receiving the dialing information, the first phone 102 is further configured for dialing the telephone number associated with the destination telephone 106 and establishing a telephone network connection with the destination telephone 106.

In the exemplary embodiment, the first/gateway telephone 102 is further configured for communicating audio stream data between the second telephone 104 and the destination telephone 106. For example, the first/gateway telephone 102 is configured for communicating audio stream data between the second/requesting telephone 104 and the first/gateway telephone 102, via the short-range wireless connection, said audio stream data being received from/directed to the destination telephone 106 via the telephone network connection. In current embodiments, the short-range wireless connection may utilize a telephone profile. For example, if the first telephone 102 and the second telephone 104 are connected via a BLUETOOTH® connection, the short-range wireless connection may utilize a telephone profile defined for BLUETOOTH®, such as the Cordless Telephony Profile (CTP).

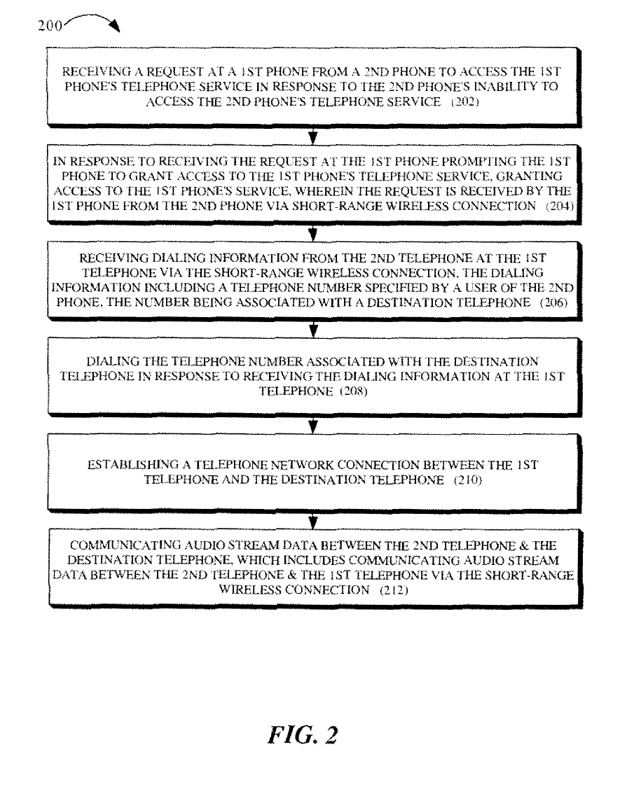

FIG. 2 is a flow chart illustrating a method for providing telephone service access via a gateway telephone in accordance with an exemplary embodiment of the present invention. The method 200 includes receiving a request at a first telephone from a second telephone to access the first telephone's telephone service in response to the second telephone's inability to access the second telephone's telephone service 202. The method 200 further includes in response to receiving the request at the first telephone prompting the first telephone to grant access to the first telephone's telephone service, granting access to the first telephone's telephone service for use by the second telephone, wherein the request is received by the first telephone from the second telephone via a short-range wireless connection 204. The method 200 further includes receiving dialing information from the second telephone at the first telephone via the short-range wireless connection, the dialing information including a telephone number specified by a user of the second telephone, the telephone number being associated with a destination telephone 206. The method 200 further includes dialing the telephone number associated with the destination telephone in response to receiving the dialing information at the first telephone 208. The method 200 further includes establishing a telephone network connection between the first telephone and the destination telephone 210. The method 200 further includes communicating audio stream data between the second telephone and the destination telephone, wherein the step of communicating audio stream data between the second telephone and the destination telephone includes communicating audio stream data between the second telephone and the first telephone via the short-range wireless connection 212. For example, the short-range wireless connection may be a secured connection, such as a secured BLUETOOTH® connection. Further, the short-range wireless connection may utilize a telephone profile defined for a secured connection, such as a secured BLUETOOTH® connection, for allowing audio stream data to be communicated between the second/requesting telephone and the first/gateway telephone.

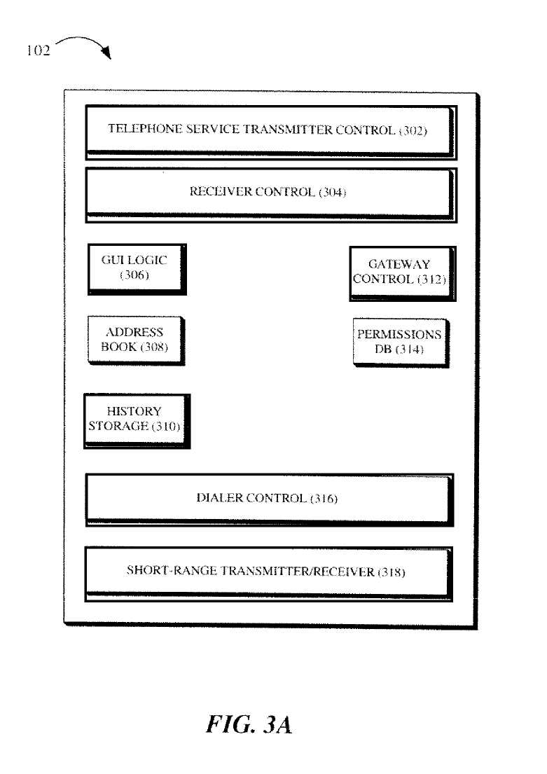

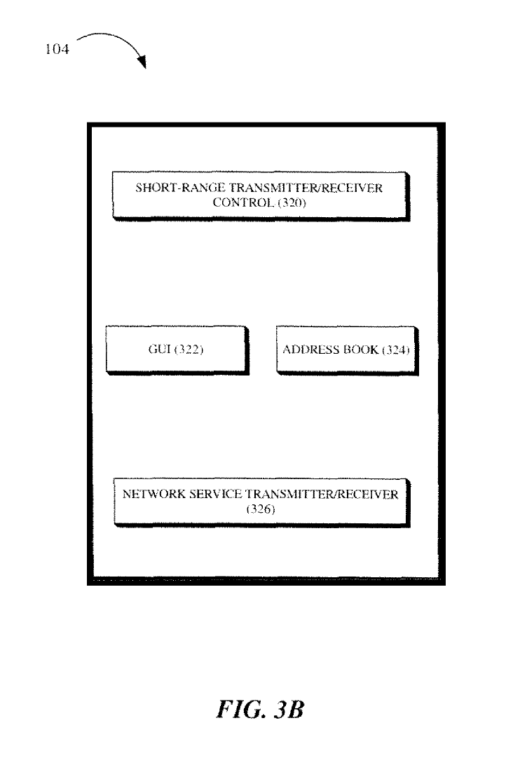

Referring generally to FIGS. 3A and 3B illustrations of the first/gateway telephone 102 and the second/requesting telephone 104 are shown respectively, in accordance with an exemplary embodiment of the present invention. The first/gateway telephone 102 may include one or more of the following: a telephone service transmitter control 302; a receiver control 304; Graphical User Interface (GUI) logic 306; an address book 308; history storage 310; gateway control 312; permissions database 314; dialer control 316; and a short-range transmitter/receiver 318. The second/requesting telephone 104 may include one or more of the following: a short range transmitter/receiver control 320; a Graphical User Interface (GUI) 322; an address book 324; and a network service transmitter/receiver 326.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to connect to other data processing systems or storage devices through intervening private or public networks. Telephone modems, cable or DSL modems and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages are to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for providing telephone service, comprising:
receiving a request at a first telephone from a second telephone to access the first telephone's telephone service in response to the second telephone's inability to access the second telephone's telephone service; and
in response to receiving the request at the first telephone prompting the first telephone to grant access to the first telephone's telephone service, granting access to the first telephone's telephone service for use by the second telephone,
wherein the request is received by the first telephone from the second telephone via a short-range wireless connection.

2. A method as claimed in claim 1, further comprising:
receiving dialing information from the second telephone at the first telephone via the short-range wireless connection, the dialing information including a telephone number specified by a user of the second telephone, the telephone number being associated with a destination telephone.

3. A method as claimed in claim 2, further comprising:
in response to receiving the dialing information at the first telephone, dialing the telephone number associated with the destination telephone.

4. A method as claimed in claim 3, further comprising:
establishing a telephone network connection between the first telephone and the destination telephone.

5. A method as claimed in claim 4, further comprising:
communicating audio stream data between the second telephone and the destination telephone.

6. A method as claimed in claim 5, wherein the step of communicating audio stream data between the second telephone and the destination telephone includes communicating audio stream data between the second telephone and the first telephone via the short-range wireless connection.

7. A method as claimed in claim 6, wherein the short-range wireless connection is a secured connection.

8. A method as claimed in claim 7, wherein the short-range wireless connection utilizes a telephone profile defined for the secured connection for allowing audio stream data to be communicated between the second telephone and the first telephone.

9. A computer program product, comprising:
a computer useable medium including computer usable program code for performing a method for providing telephone service, the computer program product including:
computer usable program code for receiving a request at a first telephone from a second telephone to access the first telephone's telephone service in response to the second telephone's inability to access the second telephone's telephone service; and
computer usable program code for granting access to the first telephone's telephone service for use by the second telephone in response to receiving the request at the first telephone prompting the first telephone to grant access to the first telephone's telephone service,
wherein the request is received by the first telephone from the second telephone via a short-range wireless connection.

10. A computer program product as claimed in claim 9, further comprising:
computer usable program code for receiving dialing information from the second telephone at the first telephone via the short-range wireless connection, the dialing information including a telephone number specified by a user of the second telephone, the telephone number being associated with a destination telephone.

11. A computer program product as claimed in claim 10, further comprising:
computer usable program code for dialing the telephone number associated with the destination telephone in response to receiving the dialing information at the first telephone.

12. A computer program product as claimed in claim 11, further comprising:
computer usable program code for establishing a telephone network connection between the first telephone and the destination telephone.

13. A computer program product as claimed in claim 12, further comprising:
computer usable program code for communicating audio stream data between the second telephone and the destination telephone.

14. A computer program product as claimed in claim 13, wherein the step of communicating audio stream data between the second telephone and the destination telephone includes communicating audio stream data between the second telephone and the first telephone via the short-range wireless connection.

15. A computer program product as claimed in claim 14, wherein the short-range wireless connection is a secured connection.

16. A computer program product as claimed in claim 15, wherein the short-range wireless connection utilizes a telephone profile defined for the secured connection for allowing audio stream data to be communicated between the second telephone and the first telephone.

17. A system, comprising:
a first telephone configured with a short-range wireless protocol; and
a second telephone configured with the short-range wireless protocol and further configured for communicatively coupling with the first telephone via a short-range wireless connection,
wherein the first telephone is further configured for granting the second telephone access to the first telephone's telephone service via the short-range wireless connection.

18. A system as claimed in claim 17, wherein the short-range wireless connection is a secured connection.

19. A system as claimed in claim 18, wherein the first telephone is further configured with means for selectively allowing access of the second telephone to the telephone service of the first telephone.

20. A system as claimed in claim 19, wherein the first telephone is further configured with:
means for receiving dialing information from the second telephone at the first telephone via the short-range wireless connection, the dialing information including a telephone number specified by a user of the second telephone, the telephone number being associated with a destination telephone;
means for dialing the telephone number associated with the destination telephone in response to receiving the dialing information at the first telephone;
means for establishing a telephone network connection between the first telephone and the destination telephone; and
means for communicating audio stream data between the second telephone and the destination telephone.
